(19) United States
(12) Patent Application Publication
(10) Pub. No.: US 2009/0126587 A1
(43) Pub. Date: May 21, 2009

(54) Method and Device for Creating a Pattern on an Erasable and Re-Usable Gravure Printing Form

(75) Inventors: Hartmut Fuhrmann, Bobingen (DE); Mladen Frlan, Gersthofen (DE)

Correspondence Address: COHEN, PONTANI, LIEBERMAN & PAVANE LLP, 551 FIFTH AVENUE, SUITE 1210, NEW YORK, NY, 10176, US

(73) Assignee: MAN ROLAND DRUCKMASCHINEN AG, Offenbach (DE)

(21) Appl. No.: 12/084,395

(22) PCT Filed: Oct. 28, 2006
(86) PCT No.: PCT/EP2006/010395

§ 371 Date: Apr. 30, 2008

(30) Foreign Application Priority Data
Nov. 2, 2005 (DE) 10 2005 052 157.6

(51) Int. Cl. B41M 1/10

(52) U.S. Cl. 101/170

(57) ABSTRACT

The aim of the invention is to further improve the ablation precision in terms of structuring the depressions of the basic grid of a gravure printing form and the printing behaviour of the depressions of a basic grid of an erasable and re-usable gravure printing form, by increasing the uniformity of the base of said depressions. To achieve this, the filler material that fills the erasable, re-usable printing gravure form is removed using laser beams, whose intensity profile over the cross-section of the laser beam corresponds to a pillbox profile.

The invention pertains to a process and to a device for imaging an erasable and reusable gravure form according to the introductory clauses of Claims 1 and 9.

The gravure printing process is an especially simple process, which is characterized in that the inking does not first have to reach a state of equilibrium as is usually the case in offset single-color systems; on the contrary, it offers the substrate the correct amount of ink almost immediately. A very high level of print quality is achieved with gravure printing, and an extremely wide variety of substrates can be printed. Counting against this advantage is the considerable amount of effort usually required to produce a gravure form.

Printing presses are known, furthermore, in which different printing processes can be used. The course of production on such presses is made more difficult by the fact that the different printing processes require different procedures for producing the printing forms in question. In particular, the production of a gravure form is much more complicated and requires much longer setup times than the production of an offset form, because special equipment and procedures are required to produce a gravure form.

For example, erasable gravure forms are discussed in EP 0 730 953 B1 and EP 0 813 957 B1, which have the goal of simplifying the production of gravure forms.

Specifically, those documents discuss a prestructured blank gravure form with a basic screen designed to accept at least the maximum amount of ink to be transferred, where the basic screen is filled in a first step with a liquefiable substance by an applicator device. The filler substance can be a thermoplastic resin or a wax, a varnish, or a crosslinkable polymer melt or solution, which is also called a “reactive system” and which is characterized by an extremely high degree of abrasion resistance, or UV printing ink can be used.

After the cells between the cell walls of the gravure form have been filled with the liquefied substance, the desired image can be “burned” into the gravure form by the thermal energy of an image point transfer unit, especially by means of a laser, in analogy to an external drum platesetter. NdYAG or NdYLF lasers are preferably used, which can be switched between several intensity levels by means of an acousto-optic modulator. Depending on the required resolution, it is also possible to use CO₂ lasers.

In principle, ablation imaging can address areas (image pixels) which are smaller than the elements of the basic screen of the blank gravure form, and in particular ablation imaging can even be carried out essentially independently of the basic screen. Nevertheless, ablation imaging can also conform to the basic screen; that is, it can stand in a certain geometric relationship to it. In the ideal case, the ablation imaging step structures the cells of the basic screen in the manner required by process engineering.

Now the gravure form can be inked by means of an inking system, so that the substrate can be printed by the gravure process. After printing is complete, the surface of the gravure form is regenerated by cleaning off the ink residues; by removing the liquefiable substance, preferably completely, from the prestructured cells; and by filling the cells uniformly again.

The goal described in those documents is to simplify the production of a gravure form and the re-equipping of the gravure press.

It is known that the blank gravure form which is used is provided with a basic screen covering the entire area which performs the printing, the screen being designed to accept the maximum amount of ink to be transferred. This basic screen is filled with a filler material to a level flush with the cell walls of the basic screen. Then an image point transfer unit is used to remove the filler material partially or completely from the cells of the basic screen in accordance with the image data. Thus a ready-to-print gravure form is obtained from the blank gravure form. After the printing order has been completed with this gravure form, the residual ink and the filler material remaining in the basic screen after the imaging step are removed partially or completely, and the basic screen is filled uniformly again to the level of the cell walls. Thus the gravure form is ready to be imaged again for a new printing order.

Against this background, the invention is therefore based on the task of elaborating a process and a device for imaging an erasable and reusable gravure form of the general type in question in such a way that the precision of ablation with respect to the structuring of the cells of the basic screen and the manner with which the cells of the basic screen print-out are improved by giving the bottoms of the cells a higher degree of uniformity.

This task is accomplished by the process steps of Claim 1 and by the device for implementing the process according to Claim 9.

In contrast to conventional gravure forms, furthermore, the incorporation of the basic screen and the incorporation of the image data into the reusable gravure form are carried out in two separate process steps, which makes possible a high degree of flexibility with respect to the structure of the image and allows the structure of the image to be adapted to the requirements of the subject to be printed and to the requirements of the gravure printing process.

The basic screen, typically 70 to 120 lines (l)/cm, can be selected in accordance with the demands of the printing process; for example, different raster angles can be selected to avoid Moiré effects, or the shape and size can be designed to achieve good ink transfer and to ensure that the support functions are optimally fulfilled with respect to the doctor blades. The image data are preferably laid, so to speak, over the basic screen at a much higher resolution of preferably 300 to 1,000 l/cm. Through the choice of the space frequency of the basic screen and the space frequency of the raster image, the periodicity of a possible Moiré effect between the raster image and the basic screen will be at wavelengths of less than about 50 μm and therefore be invisible to the human eye. Thus the image data can be represented in different ways and adapted to the requirements of the print product in question without danger of a Moiré pattern being created between the basic screen and the raster image. In cases of multi-color printing, the accustomed angling of the basic screen as also used in conventional gravure printing can therefore be used to avoid Moiré effects between the individual printing ink colors. In the case of Moiré-critical image contents, furthermore, it is possible to work not only with different anglings but also with basic screens of different space frequencies as a way of avoiding Moiré effects between the different colors.

So that the filler material can be removed in accordance with the desired image, the gravure form is therefore treated with one or more laser beams, which can come from one or more lasers, and the intensity of the laser beam is modulated in such a way that the filler material is removed from the image areas. Several intensity levels can be set, so that the quantity of filler material removed and the depth of the laser-beam engraving of the filler material can be changed.

To achieve attractive print quality, the data density which can be transferred by the laser platesetter should be in the range between 10⁵ units per cm² and 10⁶ units per cm². This can be accomplished in various ways. For example, the data density which can be achieved at high resolution and a small number of power levels is similar to that which can be obtained at lower resolution and a higher number of power levels for the laser platesetter.

The diameters (spot diameters) which the laser beams used to create the image produced on the filler material to be removed, the addressability of the image points, and the number of intensity levels, that is, engraving depths, which are used to write the image data can be selected so that either relatively modest or the highest possible demands on print quality can be fulfilled. With the reusable gravure form, good results have been obtained at a resolution of 330 l/cm and 16 power levels for the laser, but even higher resolutions are possible.

It is possible to expose only parts of the cells of the basic screen, which is advantageous in particular for the reproduction of lettering and line art.

To image the form, one or more modulatable laser beams are aimed at the cylindrical gravure form to be imaged, which rotates during this process. The laser beams are moved simultaneously along the axis of the cylinder, so that spiral write tracks are produced, separated from each other by a distance equal to the reciprocal of the resolution of the laser beams.

As shown in FIG. 1, it is advantageous for the intensity profile at the focus of the laser beam to approximate a so-called “pill box” profile. The intensity of the laser beams—in contrast to a Gaussian distribution—is nearly constant over the entire diameter of the laser beam. FIG. 1 shows a comparison between a laser intensity with a Gaussian profile (upper half) and a laser intensity with a “pill box” profile. In the case of the Gaussian profile, the track width of the write track in the filler material depends on the intensity, whereas (see lower half of FIG. 1) the track width in the filler material in the case of the “pill box” profile is independent of the intensity of the laser beam. Thus, independently of the intensity, the write tracks have the same only slightly overlapping width. No undesirable write lines are formed, which can interfere with printing as in the case of a Gaussian profile.

Because the erasable and reusable gravure form can have various dimensions to suit different formats, the imaging device is designed so that cylinders or sleeves with different diameters and lengths can be imaged. For this purpose, it is advisable for the blank gravure form to be mounted on two pairs of support rollers, one at each end of the blank gravure form. Whereas one pair of support rollers, namely, the pair which acts as the drive, is stationary, the distance between the second pair of support rollers and the first can be adapted to blank gravure forms of different lengths.

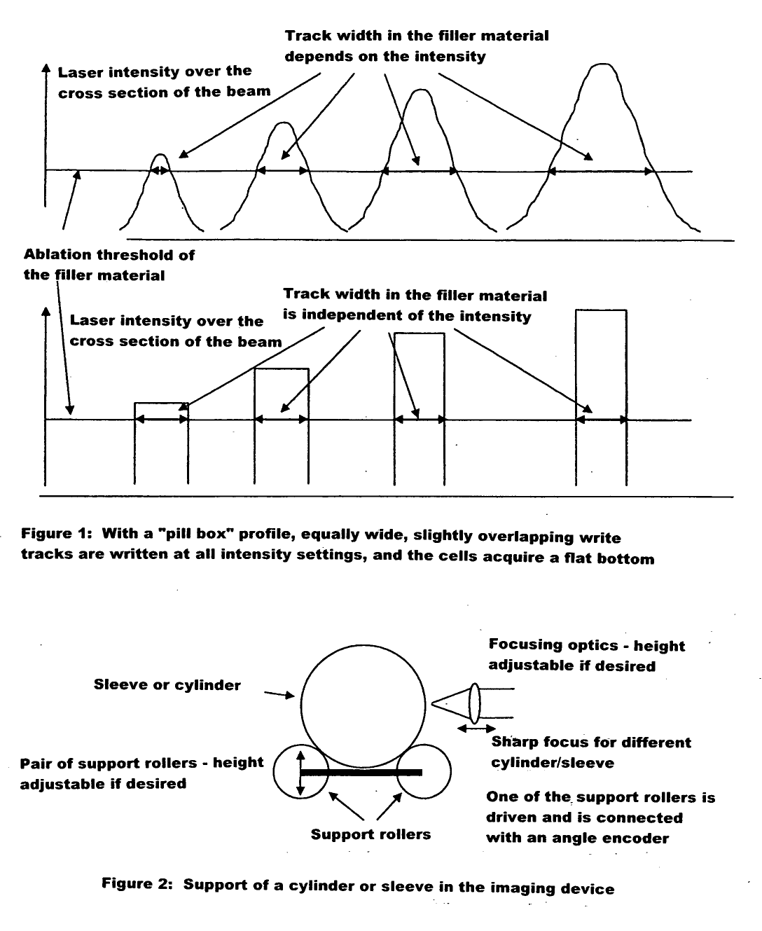

According to FIG. 2, the two pairs of support rollers can be designed so that their heights are adjustable in common to suit reusable gravure forms of different diameters; that is, their heights can be adjusted so that the imaging laser beams will always strike the crest of the blank gravure form to be imaged. Alternatively, the height of the focusing lens can be adjusted to suit the diameter of the blank gravure form in question.

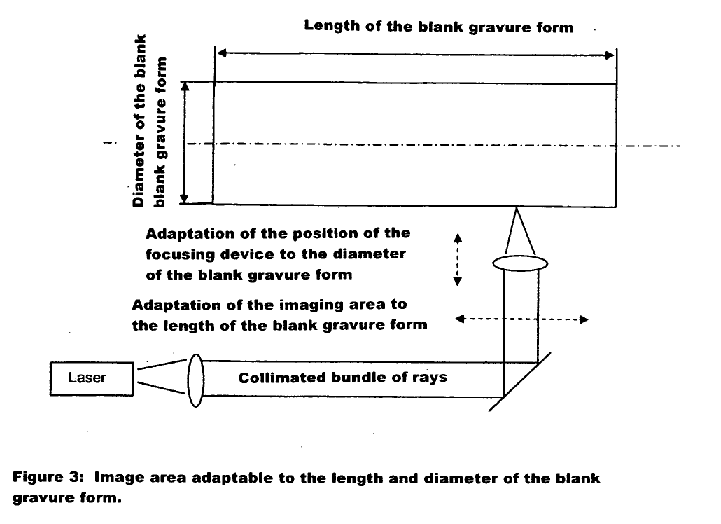

As shown in FIG. 3, to simplify this adjustment and also the adjustment to blank gravure forms different lengths, the laser beam entering the focusing lens is independent of the position of the focusing lens.

According to a preferred method for supporting the blank gravure form to be imaged, furthermore, the driving roller can have a surface which increases the friction between this roller and the erasable and reusable blank gravure form and thus guarantees that the surface velocity of the roller is precisely the same as the surface velocity of the erasable and reusable blank gravure form and that no slippage occurs between them.

1.-16. (canceled)

17. A process for gravure printing comprising:
providing a blank gravure form with a basic screen designed to accept at least the maximum amount of ink to be transferred during printing, the basic screen having cells, each cell forming at least one image pixel;
uniformly filling the cells with filler material by means of an applicator device;
removing the filler material from the image pixels to produce a screened gravure form in accordance with a desired image, wherein the filler material is ablated by at least one laser beam originating from a respective at least one laser, each beam having an intensity that is modulated so that the filler material is removed from each image pixel to a desired depth, the intensity of the beam being substantially constant over the entire cross section of the beam;
inking the screened gravure form by means of an inking system;
using the gravure form for a gravure printing process; and
regenerating the blank gravure form.

18. The process of claim 17 wherein each cell comprises a plurality of image pixels, the ablation of filler material being carried independently of the cell arrangement on the basic screen.

19. The process of claim 17 wherein gravure form is fitted to a cylinder which is rotated as the laser beam is advanced parallel to the axis, wherein the advance per revolution of the cylinder is adjusted so that it is somewhat smaller than the width of the beam, whereby the write tracks formed by the beam overlap.

20. The process of claim 17 wherein the laser beam writes image data in the filler material at a data density of 10⁴ data units per cm² to 10⁷ units per cm².

21. The process of claim 17 wherein the laser beam writes image data in the filler material at a raster width between 650 lines/cm with eight depth levels and 330 lines/cm with sixteen depth levels.

22. The process of claim 17 wherein, to reproduce delicate lettering and lines, filler material is removed only from areas of the raster cells formed by the basic screen.

23. The process of claim 17 wherein the laser beam writes image data in the filler material in the form of a frequency modulated raster.

24. The process of claim 17 wherein the laser beam writes image data in the filler material in the form of an autotypical raster.

25. The process of claim 17 wherein, to avoid Moiré effects during printing, different raster angles are used for the basic screens of the gravure forms used to print the color separations of a color print run.

26. The process of claim 25 wherein basic screens with different space frequencies are used for the gravure forms of various color separations of a color print run.

27. Gravure printing apparatus comprising an image point transfer device for imaging an erasable gravure form on a rotating gravure cylinder, the device comprising a laser for producing a laser beam and optics which diffract the laser beam so that the intensity of the beam is substantially constant over the entire cross section of the beam.

28. The apparatus of claim 27 wherein the optics split the laser beam into several beams having an intensity which can be modulated independently of the other beams.

29. The apparatus of claim 27 wherein the laser beam follows an optical path having a section with a collimated bundle of rays, the optics comprising focusing optics which receive the collimated bundle of rays and direct it toward the gravure cylinder, the focusing optics being movable to image gravure cylinders having different diameters and different lengths.

30. The apparatus of claim 27 wherein the gravure cylinder is supported at each by a pair of support rollers, wherein one of the cylinders is driven and is connected to an angle decoder which transmits an angle signal used to synchronize the modulation and axial advance of the write beams with the rotation of the gravure cylinder.

31. The apparatus of claim 30 wherein the distance between the pairs of rollers can be adjusted to adapt to the length of the gravure cylinder.

32. The apparatus of claim 30 wherein the rollers in each pair have a difference in height which can be adjusted to adapt to the diameter of the gravure cylinder.
